(19) United States
(12) Patent Application Publication
(10) Pub. No.: US 2014/0339826 A1
(43) Pub. Date: Nov. 20, 2014

(54) DIFFUSER CONTROLLER FOR TIDAL STREAM POWER GENERATION

(71) Applicant: KOREA INSTITUTE OF OCEAN SCIENCE & TECHNOLOGY (KIOST), Gyeonggi-do (KR)

(72) Inventors: Jin Hwan Ko, Seoul (KR); Kwang Soo Lee, Seoul (KR); Quang Tuyen Le, Gyeonggi-do (KR); In Suk Han, Incheon (KR)

(73) Assignee: KOREA INSTITUTE OF OCEAN SCIENCE & TECHNOLOGY (KIOST), Gyeonggi-do (KR)

(21) Appl. No.: 14/282,100

(22) Filed: May 20, 2014

(30) Foreign Application Priority Data
May 20, 2013 (KR) 10-2013-0056760

(51) Int. Cl. F03B 15/08; F03B 13/10

(52) U.S. Cl. CPC F03B 15/08; F03B 13/10
USPC 290/43

(57) ABSTRACT

Disclosed is a diffuser controller for tidal stream power generation, for use in a tidal stream power generator installed under water to generate electricity using a tidal stream. The diffuser controller includes: a turbine configured to be rotated by the tidal stream; a diffuser which is formed with an inlet through which a fluid flows into the diffuser and an outlet through which the fluid flows out from the diffuser, the turbine being fixed inside the diffuser and a rear foil being rotatably installed in the outlet; and a control unit configured to adjust an rotating angle of the rear foil depending on a direction or velocity of the tidal stream. The diffuser is configured to be rotatable.

### CROSS REFERENCE TO RELATED APPLICATIONS

This application claims priority to Korean Patent Application No. 10-2013-0056760, filed May 20, 2013, the contents of such application being incorporated by reference herein.

### BACKGROUND OF THE INVENTION

1. Field of the Invention

The present disclosure relates to a diffuser controller for tidal stream power generation, and more particularly, to a diffuser controller for tidal stream power generation which is capable of performing an active control according to variation in flow direction and flow velocity of a tidal stream.

2. Description of the Prior Art

Tidal stream power generation refers to producing electricity by installing a turbine at a place where a tidal stream flows fast and is differentiated from tidal power generation which produces electricity by rotating a turbine using a head drop while flowing seawater trapped by a dam, in that the tidal stream power generation uses natural flows of tidal streams as they are.

The tidal stream power generation has recently been researched and developed in various forms as an environment-friendly alternative energy system which does not require a dam for securing a reservoir, allows vessels to freely move, does not disturb fish migration, and does not affect the surrounding ecosystem.

In connection with this, Korean Patent No. 10-1030748 discloses “Tidal Stream Power Generator With Stream Guide Structure and Generation Turbine Separation Structure”, in which the tidal stream power generator includes a housing formed with an internal tunnel, a generation turbine installed inside the housing and provided with rotor blades, and a stream guide installed in the housing to guide a stream to the internal tunnel. The generation turbine is fixedly installed inside the internal tunnel by a connection member, a cutoff line is formed in the housing to divide the generation turbine, in which a generation turbine unit and a base structure fixing unit that corresponds to a remaining portion are integrally provided, into the generation turbine unit and the base structure fixing unit such that the generation turbine unit can be separated from the housing. The stream guide is. formed as a tapered funnel-shaped member, of which the cross section is gradually reduced from an outer end toward an inner end coupled to the housing, such that the flow velocity of the stream is increased while the stream is flowing toward the internal tunnel and passes through the internal tunnel with the increased flow velocity. With this arrangement, it is described that the tidal stream power generator has a structure configured to guide a stream such that the flow of tidal stream is concentrated into the generation turbine so that generating efficiency can be enhanced and the generation turbine can be easily separated.

Meanwhile, a shroud is described in Journal of Korean Society of Coastal and Ocean Engineers (Vol. 24 No. 2, pp. 77-83, April, 2012). It is also described that test results have been obtained in which the flow velocity of seawater is affected by a shape angle of the shroud and according to the angle of the shroud, the maximum flow velocity within the shroud is increased and then decreased.

As such, stream guides or shrouds have been developed so as to control the velocity of tidal streams and increase the rotating velocity of a turbine for the purpose of efficient tidal stream power generation.

However, the tidal stream may periodically change its flow direction 180° and even after the flow direction is determined, the flow direction and flow velocity may vary. In conventional tidal stream power generation, a symmetric turbine blade or a duct which is relatively poor in efficiency has been used in consideration of the variation in flow direction of the tidal stream or control apparatus which is complicated or consumes a large amount of energy has been used so as to use a highly efficient asymmetric duct. As a result, improvement for this is needed.

### PRIOR ART DOCUMENT

### Patent Document

Patent Document 1: Korean Patent No. 10-1030748 (published on Apr. 26, 2011)

### SUMMARY OF THE INVENTION

An aspect of the present disclosure provides a diffuser controller for tidal stream power generation which is capable of adjusting a pitch angle of a foil that forms a diffuser so as to control a direction of the diffuser and a flow velocity of a tidal stream inside the diffuser such that tidal stream power is efficiency generated according to characteristics of the tidal stream of which the flow direction is periodically varied, and the flow velocity of the tidal stream.

In order to accomplish this, there is a provided diffuser controller for tidal stream power generation, for use in a tidal stream power generator installed in the water to generate electricity using tidal stream. The diffuser controller includes: a turbine configured to be rotated by the tidal stream; a diffuser which is formed with an inlet through which a fluid flows into the diffuser and an outlet through which the fluid flows out from the diffuser, the turbine being fixed inside the diffuser and a rear foil being rotatably installed in the outlet; and a control unit configured to adjust an rotating angle of the rear foil depending on a direction or velocity of the tidal stream, wherein the diffuser is configured to be rotatable in yaw.

In addition, in a basic setting state of the rear foil, a cross-sectional area of the outlet may be larger than that of the inlet for diffusion effect, and the rear foil is formed with a rotation axis on a front side for control of diffusion effect and yaw rotation thereof.

When the tidal stream flows from the outlet side to the inlet side, the control unit may rotate one of the rear foils in a direction where the cross-sectional area of the outlet is reduced such that the diffuser is rotated by unbalanced force.

When the diffuser is rotated 90° or more, the control unit may rotate the rear foil in a direction where the cross-sectional area of the outlet is increased.

When the tidal stream flows from the inlet side to the outlet side, the control unit may rotate the rear foils in a direction where the cross-sectional area of the outlet is decreased or increased.

The diffuser may include: a lower panel formed in a plate shape; an upper panel positioned above the lower panel and formed in a plate shape; one pair of front foils arranged in a symmetric form between the lower panel and the upper panel so as to configure the inlet; one pair of rear foils arranged in a symmetric form between the lower panel and the upper panel so as to configure the outlet; and one pair of middle foils arranged in a symmetric form between the lower panel and the upper panel so as to configure the inlet and interposed between the front foils and the rear foils. Rear ends of the front foils may be positioned inside the middle foils and rear ends of the middle foils are positioned inside the rear foils.

Each of the front foils, the middle foils, and the rear foils may have a thickness which is reduced toward the rear end thereof.

According to the present disclosure, since the rotating angle of the rear foil can be adjusted according to the direction of the tidal stream, it is possible to rotate the diffuser to be suitable for the flow of the tidal stream by rotating the rear foil in a direction where the cross-sectional area of the outlet is reduced when the tidal stream flows from the outlet side to the inlet side. In addition, the rotating angle of the rear foil can be adjusted depending on the velocity of the tidal stream so as to control the flow velocity within the diffuser. As a result, the efficiency and capacity factor of the turbine can be increased by extending the flow velocity range where power generation can be performed.

### BRIEF DESCRIPTION OF THE DRAWINGS

The above and other aspects, features and advantages of the present invention will be more apparent from the following detailed description taken in conjunction with the accompanying drawings, in which:

FIG. 1 is a perspective view illustrating a diffuser controller for tidal stream power generation according to an exemplary embodiment of the present disclosure;

FIG. 2 is a view illustrating a process of controlling the angle of rear foils in the diffuser illustrated in FIG. 1 and changing the direction of the diffuser thereby; and

FIG. 3 is a view illustrating a process of controlling the angle of the rear foils according to the flow velocity in the diffuser illustrated in FIG. 1.

### DETAILED DESCRIPTION OF THE EXEMPLARY EMBODIMENTS

Hereinafter, the preferred embodiments of the present invention will be described in detail as follows. In the description of the present invention, the description of the well-known function or structure will be omitted in order to clear the subject matter of the present invention.

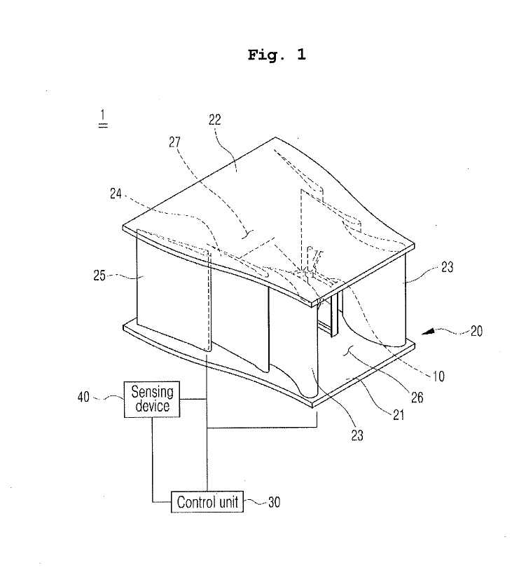

FIG. 1 is a perspective view illustrating a diffuser controller for tidal stream power generation 1 (hereinafter, simply referred to as a “diffuser controller 1”) according to an exemplary embodiment of the present disclosure.

The diffuser controller 1 according to the present disclosure is an apparatus configured to enhance tidal stream power generation efficiency in consideration of a characteristic of a tidal stream and the formation of a vortex according to the flow velocity of the tidal stream. For this purpose, the diffuser controller 1 includes a turbine 10, a diffuser 20, and a control unit 30.

The turbine 10 is configured to rotate according to the flow of tidal stream and a conventional turbine in tidal stream power generation may be used as the turbine 10. According to the type of the turbine 10 acting on the direction of tidal stream in the tidal stream power generation, the turbine 10 is classified into a Horizontal Axis Turbine (HAT) or a Vertical Axis Turbine (VAT).

FIG. 1 illustrates the turbine 10 coupled to the diffuser 20 as the VAT type. However, it natural that a HAT type turbine may be coupled to the diffuser 20.

In the present disclosure, the diffuser 20 is provided so as to increase the flow velocity of the tidal stream that passes through the turbine 10 and is usually formed in a duct shape. The diffuser 20 corresponds to a stream guide or a shroud in the prior art.

The diffuser 20 is formed with an inlet 26 through which fluid flows into the diffuser 20 and an outlet 27 through which fluid flows out from the diffuser 20. Inside the diffuser 20, the turbine 10 is fixed to be rotated according to the flow of the tidal stream so as to generate electricity. In addition, the diffuser 20 is configured such that the cross-sectional area of the outlet 27 is larger than that of the inlet 26 so as to make the flow velocity flowing inside the diffuser 20 increase using a diffusion effect.

Specifically, the diffuser controller 1 includes a lower panel 21, an upper panel 22, front foils 23, middle foils 24, and rear foils 25.

In the following description of the diffuser controller 1 according to the present disclosure, the side where the front foils 23 are formed will be referred to as a front side and the side where the rear foils 25 are formed will be referred to as a rear side.

The lower panel 21 is formed in a quadrangle plate shape, preferably in a trapezoid plate shape. That is, the width of the inlet 26 side is relatively narrow and the outlet 27 side is relatively wide.

The upper panel 22 is positioned above the lower panel 21 in parallel to the lower panel 21. In addition the upper panel 22 is formed preferably in a shape which is the same as that of the lower panel 21.

The front foils 23 are provided in one pair to be positioned such that the front foils 23 are spaced apart from each other to the opposite sides between the lower panel 21 and the upper panel 22 and in a symmetric form. The front foils 23 are each formed in a plate shape and laid vertically such that the front foils 23 are coupled to the lower panel 21 and the upper panel 22 at the bottom and top ends thereof, respectively, so as to define a conduit.

When the front foils 23 are coupled to the lower panel 21 and the upper panel 22, the inlet 26 of the diffuser 20 is formed. In order to ensure smooth inflow of fluid through the inlet 26, the inner surfaces of the front foils 23 may be formed as curved surfaces and in particular, the interval between the front foils 23 is preferably decreased and then increased toward the rear side.

The middle foils 24 are provided in one pair to be positioned such that the middle foils 24 are spaced apart from each other to the opposite sides between the lower panel 21 and the upper panel 22 and in a symmetric form. Each of the middle foils 24 are also formed in a plate shape and laid vertically such that the middle foils 24 are coupled to the lower panel 21 and the upper panel 22 at the bottom and top ends thereof, respectively, so as to define a conduit. At this time, the rear ends of the front foils 23 are positioned inside the middle foils 24 such that the fluid which has passed through the inside of the front foils 23 may naturally move toward the middle foils 24.

The interval between the middle foils 24 is generally wider than the interval between the front foils 23 so that the flow velocity of the fluid that has moved to the middle foils 24 can be increased due to the diffusion effect.

The rear foils 25 are provided in one pair to be positioned such that the rear foils 25 are spaced apart from each other to the opposite sides between the lower panel 21 and the upper panel 22 and in a symmetric form. The rear foils 25 are also formed each in a plate shape and laid vertically such that the rear foils 25 are coupled to the lower panel 21 and the upper panel 22 at the bottom and top ends thereof, respectively, so as to define a conduit. At this time, the rear ends of the middle foils 24 are positioned inside the rear foils 25 such that fluid which has passed through the inside of the middle foils 24 may naturally move toward the rear foils 25.

In the diffuser controller 1 according to the present disclosure, it is desirable that each of the front foils 23, the middle foils 24, and the rear foils 25 is formed in a shape of which the thickness is reduced toward the rear end for the purpose of natural flow of the fluid.

The rear foils 25 are not laid in parallel to the longitudinal direction of the diffuser 20 but laid to be inclined such that the interval at the rear side of the rear foils 25 is wider than the interval at the front side of the rear foils 25. Then, the diffusion effect of the fluid passing through the rear foils 25 from the front foils 23 is increased such that the flow velocity of the fluid flowing in the inside of the diffuser 20 can be increased. This state in which the rear foils 25 have a wider interval at the rear side thereof will be referred to as a “basic setting state” in the present disclosure.

However, in the diffuser 20 according to the present disclosure, each of the rear foils 25 may be coupled to the diffuser 20 to be rotatable within a predetermined range of a rotating angle about a rotation axis B rather than being fixed to the basic setting state in the direction thereof. The rear foils 25 provided in one pair may be configured such that they are individually rotatable on the diffuser 20 or only one of the rear foils 25 is rotatable.

The rotation axis B of the rotating rear foil 25 is formed preferably in a direction orthogonal to the lower panel 21 and the upper panel 22.

The diffuser 20 according to the present disclosure is configured to be rotatable in yaw, especially about a rotation axis A formed in a vertical direction. That is, since the tidal stream may vary in flow direction and flow velocity even after the flow direction (the flow direction of a fluid) is determined to be periodically changed 180°, the diffuser 20 is configured to be rotated according to the characteristics of the tidal stream so that the front side of the diffuser 20 is facing the direction of the tidal stream (on the front foil 23 side) and, thus, the flow velocity within the diffuser 20 can be increased to enhance the power generation efficiency of the turbine 10.

In addition, in order to rotate the rear foils 25, a control unit 30 is provided on a side of the diffusers 20 and a driving unit (e.g., an electric motor or a hydraulic motor) may be provided in the control unit 30 to rotate the rear foils 25.

In addition, the diffuser controller 1 according to the present disclosure may be provided with a sensing device 40 configured to sense the flow direction and flow velocity of the tidal stream in which a conventional flow velocity sensor or a flow sensor may be used as the sensing device 40. When it is determined that the front foils 23 of the diffuser 20 are not arranged to face the flow direction of the tidal stream as a result of sensing the flow direction and flow velocity of the tidal stream through the sensing device 40, the diffuser 20 may be rotated through the rotation of the rear foils 25 as described below.

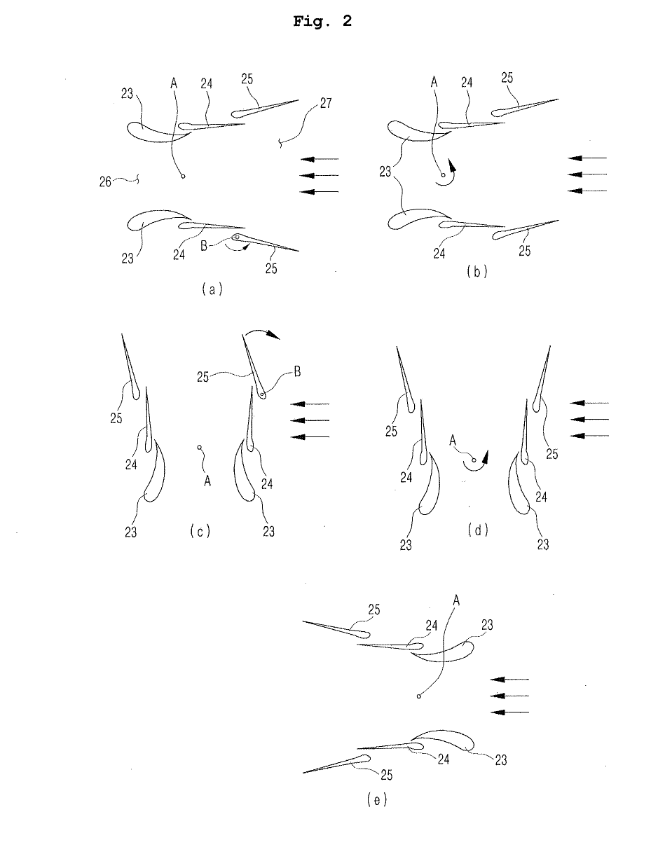

FIG. 2 is a view illustrating a process of controlling the angle of the rear foils 25 in the diffuser 20 depicted in FIG. 1, and changing the direction of the diffuser 20 by controlling the angle.

In the diffuser controller 1 according to the present disclosure, the diffuser 20 is set in a direction where the tidal stream flows from the front side of the diffuser 20 (the front foil 23 side) to the rear side (rear foil 25 side) so as to perform the tidal stream power generation. However, for example, when the flow direction of the tidal stream is changed by 180°, a process of controlling the angle of the rear foils 25 and changing the direction of the diffuser 20 by controlling the angle is performed as described below.

First, a fluid of the tidal stream flows into the diffuser 20 from the rear foil 25 side as illustrated in FIG. 2a.

At this time, the control unit 30 rotates the rear foils 25 so as to reduce the cross-sectional area of the outlet 27. That is, only one of the pair of rear foils 25 is rotated such that forces applied to the rear foils 25 by the tidal stream becomes unbalanced. For example, as illustrated in FIG. 2b, when the lower rear foil 25 is rotated (counterclockwise rotation) to make the fluid press the outer side of the rear foil 25, the diffuser 20 is biased to be rotated counterclockwise.

As a result, the diffuser 20 is rotated counterclockwise. FIG. 2c illustrates the state where the diffuser 20 is rotated 90°. When the rotating angle of the diffuser 20 is 90° or more, the control unit 30 may rotate the rotated rear foil 25 to its original position (clockwise rotation) so that a stronger force may be applied to the outer surface of the rear foil 25 by the fluid and the diffuser 20 receives a larger rotational force. As a result, the diffuser 20 may be rotated more rapidly and easily.

Of course, even if the rotated angle of the diffuser 20 is not 90° or more, in other words, even if the rotated angle is less than 90°, for example, about 80°, the rear foil 25 may also be rotated to its original position in consideration of the variation of the flow velocity and direction of the tidal stream so as to induce the rapid rotation of the diffuser 20.

When the diffuser 20 is continuously rotated and, thus, the front foil 23 is faced to the flow direction of the tidal stream, the diffuser 20 does not need to be rotated any further. At this time, the rotation of the diffuser 20 may be stopped using a separate brake device. In addition, it is desirable that the turbine 10 is in the stopped state using a brake when the diffuser 20 is rotated 180°.

According to the diffuser controller 1 according to the present disclosure, since the rotated angle of the rear foils 25 may be adjusted depending on the direction of the tidal stream, it is possible to rotate the rear foils 25 in a direction where the cross-sectional area of the outlet 27 is reduced even when the tidal stream flows from the outlet 27 to the inlet 26 such that the diffuser 20 can be rotated to be suitable for the flow of the tidal stream. As a result, it is possible to provide a tidal stream power generator capable of enhancing efficiency according to the change of flow direction of tidal stream.

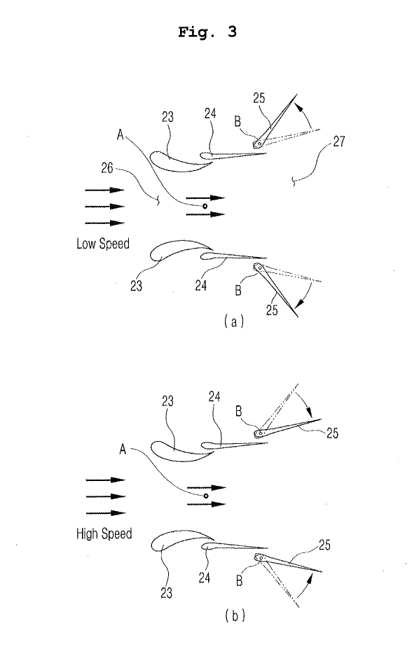

FIG. 3 is a view illustrating a process of controlling the angle of the rear foils 25 according to the flow velocity in the diffuser 20 illustrated in FIG. 1.

When the diffuser 20 is positioned in the direction where the tidal stream flows from the front side of the diffuser 20 (front foil side) to the rear side (rear foil side 25) in the diffuser controller 1 according to the present disclosure, it is also possible to control the angle of the rear foils 25 according to the flow velocity of the tidal stream, specifically in the following manner.

First, since the diffuser 20 according to the present disclosure is configured such that the cross-sectional area at the outlet 27 is larger than that at the inlet 26, in particular the interval between the rear foils 25 is increased toward the rear side, the flow velocity can be increased within the diffuser 20 using the diffusion effect of the fluid.

However, the flow velocity within the diffuser 20 is not continuously increased even if the inclined angles of the rear foils 25 are increased (the interval of the rear ends of the rear foils 25 diffuser). As the inclined angle of the rear foils 25 is increased, the flow velocity within the diffuse 20 is increased but, after reaching a peak value, the flow velocity is decreased again.

This is because the action of the vortex generated in the vicinity of the rear foils 25 is changed according to the change of the inclined angle and the growth and change of the vortex affect the flow of the fluid within the diffuser 20.

In addition, the action of the vortex changes depending on the velocity of the fluid flowing in the diffuser 20.

In the diffuser controller 1 according to the present disclosure, the inclined angle (pitch angle) of one pair of rear foils 25 is increased such that the diffusion effect within the diffuser 20 can be increased when the flow velocity of the tidal stream is relatively low.

That is, when the fluid velocity of the tidal stream is relatively low and, thus, the diffusion effect can be further increased as compared with the action of the vortex even if the inclined angle (pitch angle) of the rear foils 25 is increased to be larger than the inclined angle when the rear foil 25 is in the basic setting state, the rear foils 25 can be rotated such that the cross-sectional area of the outlet 27 can be increased. FIG. 3a illustrates such a case.

On the contrary, when the flow velocity of the tidal stream is relatively high, the inclined angle of the one pair of rear foils 25 is reduced such that the diffusion effect within the diffuser 20 can be reduced.

That is, In high the fluid velocity of the tidal stream, the diffusion effect can be considerable reduced if the inclined angle (pitch angle) of the rear foils 25 is reduced to be smaller than the inclined angle when the rear foil 25 is in the basic setting state, the rear foils 25 can be rotated such that the cross-sectional area of the outlet 27 can be reduced. FIG. 3b illustrates such a case.

As described above, in the diffuser controller for tidal stream power generation 1 according to the present disclosure, the pitch angle of the rear foils 25 is adjusted according to the change in flow velocity of tidal stream such that an optimum diffusion effect can be exhibited within the diffuser 20 while reducing the action of vortex. As a result, efficiency and capacity factor of the tidal stream power generation can be enhanced.

The diffuser controller for tidal stream power generation 1 according to the present disclosure has been described with reference to a type in which three pairs of foils (front foils 23, middle foils 24, and rear foils 25) are provided, the diffuser controller for the tidal stream power generation 1 can be configured in various types in which two or more pairs of foils are proved according to the type of the turbine and the pitch control efficiency.

Although the exemplary embodiment of the present invention is described and shown, it is obvious to a person skilled in the art that the present invention is not limited to the described embodiment and may be changed and modified in various forms without departing from the spirit and scope of the present invention. Accordingly, modifications or variations should not be individually understood in view of the technical spirit of the present invention, and it must be understood the modifications and the variations belong to the claims of the present invention.

What is claimed is:

1. A diffuser controller for tidal stream power generation, for use in a tidal stream power generator installed under water to generate electricity using tidal stream, the diffuser controller comprising:
a turbine configured to be rotated by the tidal stream;
a diffuser which is formed with an inlet through which a fluid flows into the diffuser and an outlet through which the fluid flows out from the diffuser, the turbine being fixed inside the diffuser and a rear foil being rotatably installed in the outlet; and
a control unit configured to adjust a rotating angle of the rear foil depending on a direction or velocity of the tidal stream,
wherein the diffuser is configured to be rotatable in yaw.

2. The diffuser controller of claim 1, wherein the diffuser includes:
a lower panel formed in a plate shape;
an upper panel positioned above the lower panel and formed in a plate shape;
one pair of front foils arranged in a symmetric form between the lower panel and the upper panel so as to configure the inlet;
one pair of rear foils arranged in a symmetric form between the lower panel and the upper panel so as to configure the outlet; and
one pair of middle foils arranged in a symmetric form between the lower panel and the upper panel so as to configure the inlet and interposed between the front foils and the rear foils,
wherein rear ends of the front foils are positioned inside the middle foils and rear ends of the middle foils are positioned inside the rear foils.

3. The diffuser controller of claim 2, wherein each of the front foils, the middle foils, and the rear foils has a thickness which is reduced toward the rear end thereof.

4. The diffuser controller of claim 1, wherein, at a basic setting state of the rear foil, a cross-sectional area of the outlet is larger than that of the inlet, and the rear foil is formed with a rotation axis on a front side thereof.

5. The diffuser controller of claim 4, wherein the diffuser includes:
a lower panel formed in a plate shape;
an upper panel positioned above the lower panel and formed in a plate shape;
one pair of front foils arranged in a symmetric form between the lower panel and the upper panel so as to configure the inlet;
one pair of rear foils arranged in a symmetric form between the lower panel and the upper panel so as to configure the outlet; and
one pair of middle foils arranged in a symmetric form between the lower panel and the upper panel so as to configure the inlet and interposed between the front foils and the rear foils,
wherein rear ends of the front foils are positioned inside the middle foils and rear ends of the middle foils are positioned inside the rear foils.

6. The diffuser controller of claim 5, wherein each of the front foils, the middle foils, and the rear foils has a thickness which is reduced toward the rear end thereof.

7. The diffuser controller of claim 4, wherein, when the tidal stream flows from the outlet side to the inlet side, the control unit rotates one of the rear foils in a direction where the cross-sectional area of the outlet is reduced such that the diffuser is rotated.

8. The diffuser controller of claim 7, wherein the diffuser includes:
a lower panel formed in a plate shape;
an upper panel positioned above the lower panel and formed in a plate shape;
one pair of front foils arranged in a symmetric form between the lower panel and the upper panel so as to configure the inlet;
one pair of rear foils arranged in a symmetric form between the lower panel and the upper panel so as to configure the outlet; and
one pair of middle foils arranged in a symmetric form between the lower panel and the upper panel so as to configure the inlet and interposed between the front foils and the rear foils,
wherein rear ends of the front foils are positioned inside the middle foils and rear ends of the middle foils are positioned inside the rear foils.

9. The diffuser controller of claim 8, wherein each of the front foils, the middle foils, and the rear foils has a thickness which is reduced toward the rear end thereof.

10. The diffuser controller of claim 7, wherein, when the diffuser is rotated 90° or more, the control unit rotates the rear foil in a direction where the cross-sectional area of the outlet is increased.

11. The diffuser controller of claim 10, wherein the diffuser includes:
a lower panel formed in a plate shape;
an upper panel positioned above the lower panel and formed in a plate shape;
one pair of front foils arranged in a symmetric form between the lower panel and the upper panel so as to configure the inlet;
one pair of rear foils arranged in a symmetric form between the lower panel and the upper panel so as to configure the outlet; and
one pair of middle foils arranged in a symmetric form between the lower panel and the upper panel so as to configure the inlet and interposed between the front foils and the rear foils,
wherein rear ends of the front foils are positioned inside the middle foils and rear ends of the middle foils are positioned inside the rear foils.

12. The diffuser controller of claim 11, wherein each of the front foils, the middle foils, and the rear foils has a thickness which is reduced toward the rear end thereof.

13. The diffuser controller of claim 4, wherein, when the tidal stream flows from the inlet side to the outlet side, the control unit rotates the rear foils in a direction where the cross-sectional area of the outlet is decreased or increased.

14. The diffuser controller of claim 13, wherein the diffuser includes:
a lower panel formed in a plate shape;
an upper panel positioned above the lower panel and formed in a plate shape;
one pair of front foils arranged in a symmetric form between the lower panel and the upper panel so as to configure the inlet;
one pair of rear foils arranged in a symmetric form between the lower panel and the upper panel so as to configure the outlet; and
one pair of middle foils arranged in a symmetric form between the lower panel and the upper panel so as to configure the inlet and interposed between the front foils and the rear foils,
wherein rear ends of the front foils are positioned inside the middle foils and rear ends of the middle foils are positioned inside the rear foils.

15. The diffuser controller of claim 14, wherein each of the front foils, the middle foils, and the rear foils has a thickness which is reduced toward the rear end thereof.
